(19) United States
(12) Patent Application Publication
(10) Pub. No.: US 2009/0268581 A1
(43) Pub. Date: Oct. 29, 2009

(54) OPTICAL PICK-UP DEVICE

(75) Inventors: Toyoki Tanaka, Tokyo (JP); Takahiko Nishiyama, Tokyo (JP)

Correspondence Address: MARGER JOHNSON & MCCOLLOM, P.C., 210 SW MORRISON STREET, SUITE 400, PORTLAND, OR, 97204, US

(73) Assignee: MITSUMI ELECTRIC CO., LTD., Tokyo (JP)

(21) Appl. No.: 12/064,954

(22) PCT Filed: Jun. 30, 2006
(86) PCT No.: PCT/JP2006/313156

§ 371 Date: Feb. 26, 2008

(30) Foreign Application Priority Data
Aug. 31, 2005 (JP) 2005-252847

(51) Int. Cl. G11B 7/00

(52) U.S. Cl. 369/110.01; G9B/7

(57) ABSTRACT

An optical pickup in which constituting components are arranged so that a dead space can be reduced and aberrations can also be reduced at a low manufacturing cost is provided. In an outward path for projecting a laser beam onto a recording surface 12 of an optical disc 11, the laser beam emitted from a laser diode 2 is reflected on a polarization mirror 3, polarized by a quarter wavelength plate 4, and then passed through an objective lens 5 so that the laser beam is focused on the recording surface 12 of the optical disc 11. In a returning path for receiving the laser beam reflected on the recording surface 12, the laser beam reflected on the recording surface 12 and passed through the objective lens 5 is polarized by the quarter wavelength plate 4, transmitted through the polarization mirror 3, reflected on a total reflective film 61 of the quarter wavelength plate 6, and then reflected on the polarization mirror 3 so that the laser beam is received by a photodiode 7. The laser diode 2 and the photodiode 7 are respectively provided on the opposite sides of the polarization mirror 3.

### TECHNICAL FIELD

This invention relates to an optical pick-up device, and more specifically to an optical system provided in the optical pick-up device.

### BACKGROUND ART

An optical system used in an optical pick-up device is configured to branch an outward path (beam projecting path) through which a laser beam is projected onto a recording surface of an optical disc and a returning path (beam receiving path) through which the laser beam reflected on the recording surface of the optical disc is returned. FIG. 6 shows a conventional optical pick-up device 100 provided with such an optical system (see JP-A 10-208277).

In the conventional optical pick-up device 100, a laser beam emitted from a laser diode 101 is p-polarized. Such emitted laser beam is incident on a polarization beam splitter 102, and then reflected on a beam splitting surface 103 which is inclinedly provided at an angle of 45° with respect to an optical axis direction. Thereafter, the laser beam passes through a quarter wavelength plate 104 and then passes through a semi-reflective film 111.

The laser beam that has passed through the semi-reflective film 111 is reflected on a reflective lens (flat concave lens) 105 having a total reflection film which totally reflects the laser beam. At that time, a concaved shape of the flat concave lens 105 provides aberrations for the emitted laser beam for correcting a difference in a thickness of an optical disc (112, 108). The laser beam reflected on the reflective lens 105 passes through the semi-reflective film 111 and then the quarter wavelength plate 104 again.

At this point of time, the laser beam is s-polarized since it passes through the quarter wavelength plate 104 twice. This s-polarized laser beam passes through the beam splitting surface 103 and it is circularly-polarized by a quarter wavelength plate 106 so that the laser beam is focused by an objective lens 105 so as to form an extremely small spot on an optical information recording medium 108 (112). Record, reproduction and erase of data is carried out in this state.

The laser beam reflected on the optical information recording medium 108 passes through the objective lens 107, and it is p-polarized when passing through the quarter wavelength plate 106 of which oscillating direction is perpendicular to the surface of the sheet of FIG. 6. This p-polarized laser beam is reflected on the beam splitting surface 103 of the polarization beam splitter 102 at an angle of 90° and then passes through a multi lens 109, and the laser beam is then received by a photodiode 110.

In this conventional optical pick-up device 100, two different beam paths are formed, which include a first path where the laser beam passes through the semi-reflective film 111 and then reflected on the reflective lens 105 and a second path where the laser beam is reflected on the semi-reflective film 111. However, in both the first and second paths, each of the laser beams passes the objective lens 108 to form an extremely small spot of the laser beam on the recording surface 108 or 112, and in the returning path thereof, the reflected laser beam is received by the photodiode 110.

In the conventional optical pick-up device 100, by using the polarization beam splitter 102, it is possible to arrange the laser diode 101 which emits the laser beam and the photodiode 110 which receive the laser beam on the opposite sides of the polarization beam splitter 102. Namely, as shown in FIG. 6, the laser diode 101 is arranged on the right side of the polarization beam splitter 102 and the photodiode 110 is arranged on the left side of the polarization beam splitter 102. Therefore, it is possible to arrange the main components of the optical pick-up device on the left and right sides of the polarization beam splitter 102 effectively so that a dead space in the optical pick-up device can be reduced.

However, in the conventional optical pick-up device, since many optical components such as the quarter wavelength plate 104, the semi-reflective film 111, and the reflective lens 105 are provided on the outward path of the laser beam, there is a problem in that aberrations of the laser beam on the recording surface of an optical disc become large. In particular, among such aberrations, astigmatism becomes conspicuous. In order to eliminate such astigmatism, it is necessary to raise the precision of each of the optical components. However, this approach arises another problem such as an increased manufacturing cost.

### SUMMARY OF THE INVENTION

The present invention has been made in view of the problems described above, and therefore it is an object of the present invention to provide an optical pick-up device in which constituting components are arranged so that a dead space can be reduced and reduction of aberrations can also be realized at a low manufacturing cost.

In order to achieve the object, the present invention is directed to an optical pick-up device. The optical pick-up device comprises: a light emitting element which emits a laser beam; a polarization semi-reflective member which reflects or transmits the laser beam; a quarter wavelength plate with a reflective film which reflects and polarizes the laser beam; an objective lens which projects the laser beam onto a recording surface of an optical disc; and a light receiving element which receives the laser beam; wherein the objective lens, the quarter wavelength plate, the polarization semi-reflective member, and the quarter wavelength plate with a reflective film are arranged in this order from the side of the recording surface of the optical disc in a vertical direction with respect to the recording surface of the optical disc; and the light emitting element and the light receiving element are respectively arranged on the opposite sides of the polarization semi-reflective member in a direction parallel to the recording surface of the optical disc; and wherein in an outward path for projecting the laser beam onto the recording surface of the optical disc, the laser beam emitted from the light emitting element is reflected on the polarization semi-reflective member, polarized by the quarter wavelength plate, and then passed through the objective lens so that the laser beam is focused on the recording surface of the optical disc, and in a returning path for receiving the laser beam reflected on the recording surface of the optical disc, the laser beam reflected on the recording surface of the optical disc is polarized by the quarter wavelength plate, transmitted through the polarization semi-reflective member, reflected on the reflective film of the quarter wavelength plate with a reflective film, and then reflected on the polarization semi-reflective member so that the laser beam is received by the light receiving element.

According to the present invention, since the light emitting element and the light receiving element are arranged on the opposite sides of the polarization semi-reflective member in a direction parallel to the recording surface of the optical disc, respectively, the components of the optical pick-up device can be arranged on different sides of the polarization semi-reflective member effectively so that a dead space in the optical pick-up device can be reduced. Further, according to the present invention, in the outward path for projecting the laser beam onto the disc recording surface, the laser beam emitted from the light emitting element is reflected on the polarization semi-reflecting member, polarized by the quarter wavelength plate, and then passed through the objective lens so that the laser beam is focused on the recording surface of the optical disc. Namely, in the optical pick-up device of the present invention, it is not necessary to dispose many optical components such as the quarter wavelength plate 104, the semi-reflective film 111, and the reflective lens 105 on the outward path of the laser beam as the conventional optical pick-up device 1 described above. This means that necessary minimum number of optical components are disposed on the outward path of the laser beam, and this makes it possible to reduce aberrations of the laser beam on the recording surface of the optical disc. Further, since it is also possible to reduce astigmatism effectively, a manufacturing cost for eliminating such astigmatism becomes unnecessary.

In the optical pick-up device of the present invention, it is preferred that the polarization semi-reflective member includes a polarization mirror having a polarization film provided on the side of the light emitting element thereof and a light transmissive body provided on the side of the light receiving element thereof, wherein the polarization mirror is inclinedly arranged at an angle of 45° with respect to the recording surface of the optical disc so that in the outward path the laser beam emitted from the light emitting element is reflected on the polarization film of the polarization mirror at an angle of 90° toward the recording surface of the optical disc and in the returning path the laser beam reflected on the reflective film of the quarter wavelength plate with a reflective film is reflected on the polarization film at an angle of 90° toward the light receiving element.

Further, in the optical pick-up device of the present invention, it is preferred that the polarization semi-reflective member includes a wedge-shaped polarization mirror having a polarization film provided on the side of the light emitting element thereof and a wedge-shaped light transmissive body provided on the side of the light receiving element thereof, wherein the wedge-shaped polarization mirror is inclinedly arranged at an angle of 45° with respect to the recording surface of the optical disc so that in the light emitting path the laser beam emitted from the light emitting element is reflected on the polarization film of the wedge-shaped polarization mirror at an angle of 90° toward the recording surface of the optical disc and in the returning path the laser beam reflected on the reflective film of the quarter wavelength plate with a reflective film is reflected on the polarization film at an angle of 90° toward the light receiving element.

Furthermore, in the optical pick-up device of the present invention, it is preferred that the polarization semi-reflective member includes a polarization beam splitter having a first prism provided on the side of the light emitting element thereof, a second prism provided on the side of the light receiving element thereof, and a semi-reflective film provided between joint surfaces of the first and second prisms, wherein the semi-reflective film of the polarization beam splitter is inclinedly arranged at an angle of 45° with respect to the recording surface of the optical disc so that in the outward path the laser beam emitted from the light emitting element is reflected on the semi-reflective film of the polarization beam splitter at an angle of 90° toward the recording surface of the optical disc and in the returning path the laser beam reflected on the reflective film of the quarter wavelength plate is reflected on the semi-reflective film of the polarization beam splitter at an angle of 90° toward the light receiving element.

According to these embodiments having the above structures, since the light emitting element and the light receiving element are arranged on the opposite sides of the polarization semi-reflective member in a direction parallel to the recording surface of the optical disc, respectively, the components of the optical pick-up device can be arranged on different sides of the polarization semi-reflective member effectively so that a dead space in the optical pick-up device can be reduced. Further, according to these embodiments, in the outward path for projecting the laser beam onto the disc recording surface, the laser beam emitted from the light emitting element is reflected on the polarization semi-reflecting member (that is, the polarization mirror, the wedge-shaped polarization mirror or the polarization beam splitter), polarized by the quarter wavelength plate, and then passed through the objective lens so that the laser beam is focused on the recording surface of the optical disc. Namely, in the optical pick-up device of the present invention, it is not necessary to dispose many optical components such as the quarter wavelength plate 104, the semi-reflective film 111, and the reflective lens 105 on the outward path of the laser beam as the conventional optical pick-up device 1 described above. This means that necessary minimum number of optical components are disposed on the outward path of the laser beam, and this makes it possible to reduce aberrations of the laser beam on the recording surface of the optical disc. Further, since it is also possible to reduce astigmatism effectively, a manufacturing cost for eliminating such astigmatism becomes unnecessary.

In particular, according to the embodiment provided with the wedge-shaped polarization mirror, in the case where non-parallel beams are incident on the wedge-shaped polarization mirror, it is possible to cancel the astigmatism produced by the non-parallel beams effectively.

The above and other objects, features and advantages of the present invention will be apparent from the following description when taken in conjunction with the accompanying drawings which illustrate preferred embodiments of the present invention by way of example.

### BRIEF DESCRIPTION OF THE DRAWINGS

FIG. 1 is a schematic view which schematically shows a concept of an optical system of an optical pick-up device of a first embodiment according to the present invention.

FIG. 2 is a perspective view which shows an actual embodiment of the first embodiment shown in FIG. 1.

FIG. 3 is a schematic view which schematically shows a concept of an optical system of an optical pick-up device of a second embodiment according to the present invention.

FIG. 4 is a perspective view which shows an actual embodiment of the second embodiment shown in FIG. 3.

FIG. 5 is a schematic view which schematically shows a concept of an optical system of an optical pick-up device of a third embodiment according to the present invention.

FIG. 6 is a schematic view which schematically shows a concept of an optical system of a conventional optical pick-up device.

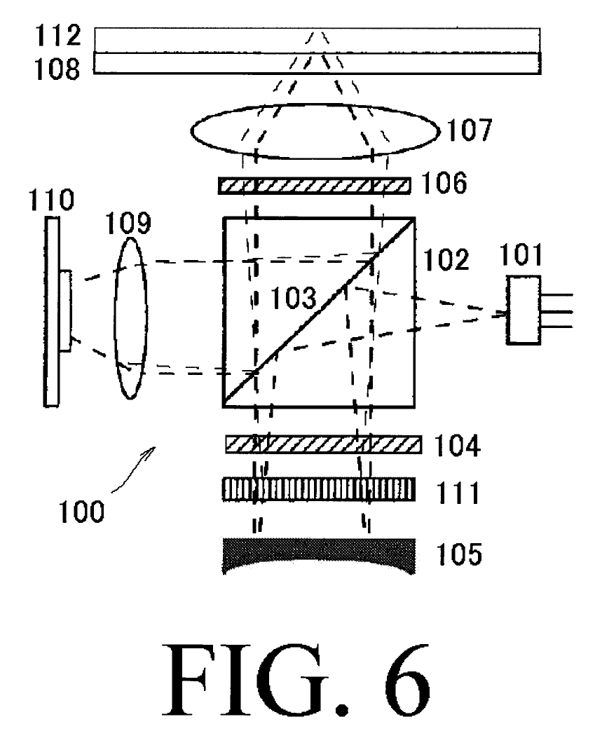

### DETAILED DESCRIPTION OF THE PREFERRED EMBODIMENTS

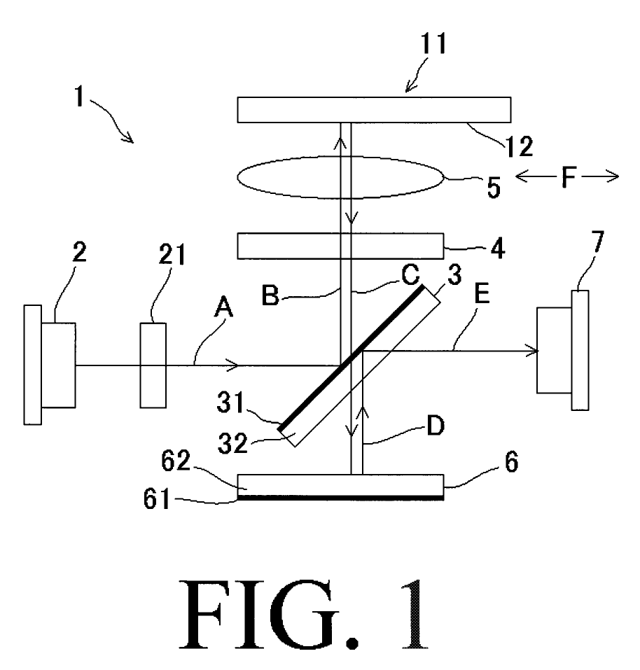

Hereinbelow, with reference to FIG. 1, a first embodiment of an optical pick-up device according to the present invention will be described. FIG. 1 is a schematic view which schematically shows a concept of an optical system of an optical pick-up device of a first embodiment according to the present invention.

In FIG. 1, the reference numeral 1 denotes the optical system of the pick-up device, which includes a laser diode 2 which is a light emitting element that emits a laser beam; a diffraction grating 21 which polarizes the laser beam emitted from the laser diode 2, a polarization mirror 3 which is a polarization semi-reflective member that reflects or transmits the laser beam; a quarter wavelength plate 4 which polarizes the laser beam; an objective lens 5 which projects the laser beam onto a recording surface 12 of an optical disc; a quarter wavelength plate 6 with a total reflective film (hereinafter, simply referred to as “quarter wavelength plate 6”) that reflects and polarizes the laser beam; and a photodiode 7 which is a light receiving element that receives the laser beam.

In the optical system, the objective lens 5, the quarter wavelength plate 4, the polarization mirror 3 which is a polarization semi-reflective member, and the quarter wavelength plate 6 are arranged in a perpendicular direction with respect to the recording surface of the optical disc in this order. The laser diode 2 which is a light emitting element and the photodiode 7 which is a light receiving element are arranged on the opposite sides of the polarization mirror 3 which is a polarization semi-reflective member in a direction parallel to the recording surface 12 of the optical disc, respectively.

In an outward path (beam projecting path) for projecting the laser beam onto the recording surface 12 of the optical disc, the laser beam emitted from the laser diode 2 which is a light emitting element is reflected on the polarization mirror 3 which is a polarization semi-reflective member, polarized by the quarter wavelength plate 4, and then passed through the objective lens 5 so that the laser beam is focused on the recording surface 12 of the optical disc. In a returning path (beam receiving path) for receiving the laser beam reflected on the recording surface 12 of the optical disc, the laser beam reflected on the recording surface 12 of the optical disc is diverged by the objective lens 5, polarized by the quarter wavelength plate 4, transmitted through the polarization mirror 3 which is a polarization semi-reflective member, reflected on the reflective film 61 of the quarter wavelength plate 6 with a reflective film, and then reflected on the polarization mirror 3 which is a polarization semi-reflective member so that the laser beam is received by the photodiode 7 which is a light receiving element.

Note that in FIG. 1 the optical disc is indicated by the reference numeral 11, and the recording surface is indicated by the reference numeral 12 as described above. Further, the outward path of the laser beam is indicated by the arrows A and B in FIG. 1, and the returning path of the laser beam is indicated by the arrows C, D and E in FIG. 1.

As described above, the objective lens 5, the quarter wavelength plate 4, the polarization mirror 3, and the quarter wavelength plate 6 with a reflective film are arranged in a perpendicular direction with respect to the recording surface 12 of the optical disc 11 in this order. Further, the laser diode 2 and the photodiode 7 are arranged on the opposite sides of the polarization mirror 3 in a direction parallel to the recording surface 12 of the optical disc 11 (which is a direction indicated by the arrow F in FIG. 1).

The laser diode 2 is a light emitting element of the laser beam. The beam emitting direction is set so as to be directed to a polarization film 31 of the polarization mirror 3.

The polarization mirror 3 which is a polarization semi-reflective member includes the polarization film 31 provided on the side of the laser diode 2 thereof and a transmissive body 32 provided on the side of the photodiode 7 thereof. In other word, the transmissive body 32 is provided on the surface of the polarization film 31 which is opposite to the reflective surface thereof.

In the first embodiment, the polarization mirror 3 is provided below the recording surface 12 in a state that it is inclined at an angle of 45° with respect to a direction which is in parallel to the recording surface 12 (indicated by the arrow F). Due to this inclination angle of the polarization mirror 3, the laser beam which is incident on the polarization film 31 through the diffraction grating 21 in the outward path is reflected at an angle of 90° toward the recording surface 12. Further, in the returning path of the laser beam, the laser beam which is reflected on a total reflective film 61 of the quarter wavelength plate 6 is reflected on the polarization film 31 at an angle of 90° toward the photodiode 7.

The quarter wavelength plate 4 is arranged on the side of the polarization mirror 3 which faces the recording surface 12, that is, the quarter wavelength plate 4 is arranged between the polarization mirror 3 and the objective lens 5 which will be described later in detail. The quarter wavelength plate 4 is provided for circularly polarizing the laser beam which is incident thereon from the polarization mirror 3 in the outward path of the laser beam as well as for linearly polarizing the laser beam which is incident thereon from the objective lens 5 in the returning path of the laser beam.

The objective lens 5 is arranged on the side of the quarter wavelength plate 4 which faces the recording surface 12, that is, the objective lens 5 is arranged between the quarter wavelength plate 4 and the recording surface 12. The objective lens 5 is provided for converging the laser beam passed through the quarter wavelength plate 4 in the outward path of the laser beam as well as for diverging the laser beam reflected on the recording surface 12 in the returning path of the laser beam.

The quarter wavelength plate 6 includes a quarter wavelength plate portion 62 positioned on the side of the recording surface 12 and the total reflective film 62 provided on the side of the lower surface of the quarter wavelength plate portion 62. The quarter wavelength plate 6 is arranged below the polarization mirror 3 so as to extend along the direction in parallel with the recording surface 12. The quarter wavelength plate 6 is provided for polarizing the laser beam which is incident thereon from the polarization mirror 3 and for reflecting the laser beam in the returning path C of the laser beam as well as for polarizing the laser beam reflected on the total reflective film 61 of the quarter wavelength plate 6 in the returning path D of the laser beam.

The photodiode 7 which is a light receiving element that receives the laser beam is arranged so that the laser beam reflected on the polarization film 31 of the polarization mirror 3 is received by the photodiode 7 through the transmissive body 32.

Hereinbelow, a description will be made with regard to the operation and effect of the optical system of the optical pick-up device 1 of this first embodiment. First, the outward path of the laser beam will be explained. In the outward path of the laser beam, the laser beam emitted from the laser diode 2 is reflected on the polarizing film 31 of the polarization mirror 3, and then polarized by the quarter wavelength plate 4. The polarized laser beam is converged by the objective lens 5 so that it is focused on the recording surface 12.

The laser beam emitted from the laser diode 2 is initially an s-polarized laser beam. This s-polarized laser beam is reflected on the polarization film 31 of the polarization mirror 3 at an angle of 90° toward the recording surface 12.

The laser beam reflected on the polarization film 31 is incident on the quarter wavelength plate 4 so that it is circularly-polarized. The circularly-polarized laser beam is converged by the objective lens 5 so that it is focused on the recording surface 12.

Next, the returning path of the laser beam will be explained. In the returning path of the laser beam, the laser beam reflected on the recording surface 12 is diverged by the objective lens 5, and then polarized by the quarter wavelength plate 4. Thereafter, the polarized laser beam passes through the polarizing film 31 of the polarization mirror 3, and then reflected on the total reflective film 61 of the quarter wavelength plate 6. The reflected laser beam is then reflected on the polarization film 31 of the polarization mirror 3 at an angle of 90° toward the photodiode 7 and received by it.

As described above, the laser beam reflected on the recording surface 12 is diverged by the objective lens 5, and then polarized by the quarter wavelength plate 4. Therefore, the laser beam is p-polarized, of which oscillating direction is perpendicular to the s-polarized laser beam in the outward path. The thus s-polarized laser beam by the quarter wavelength plate 4 passes through the polarizing film 31 of the polarization mirror 3 and then incident on the quarter wavelength plate 6.

The laser beam which is incident on the quarter wavelength plate 6 passes through the quarter wavelength plate portion 62, and then it is reflected on the total reflective film 61 and passes through the quarter wavelength plate portion 62 again. As a result, the laser beam is s-polarized of which oscillating direction is perpendicular to the p-polarized laser beam. The s-polarized laser beam is reflected on the polarizing film 31 of the polarization mirror 3 at an angle of 90° toward the photodiode 7 and received by it.

In the first embodiment described above, since the laser diode 2 and the photodiode 7 are arranged on the opposite sides of the polarization mirror 3 in a direction parallel to the recording surface 12 of the optical disc (which is a direction indicated by the arrow F in FIG. 1), respectively, the components of the optical pick-up device 1 can be arranged on the right and left sides of the polarization mirror 3 effectively so that a dead space in the optical pick-up device 1 can be reduced. Further, in this first embodiment, it is not necessary to dispose many optical components such as the quarter wavelength plate 104, the semi-reflective film 111, and the reflective lens 105 on the outward path of the laser beam as the conventional optical pick-up device 1 described above. In this first embodiment, necessary minimum number of optical components are disposed on the outward path of the laser beam, and thus it is possible to reduce aberrations of the laser beam on the recording surface of the optical disc. Further, since the number of components is reduced, it is possible to reduce a manufacturing cost. Further, since it is also possible to reduce astigmatism effectively, a manufacturing process for eliminating the astigmatism becomes unnecessary, and thus it is possible to reduce a manufacturing cost resulted from the manufacturing process.

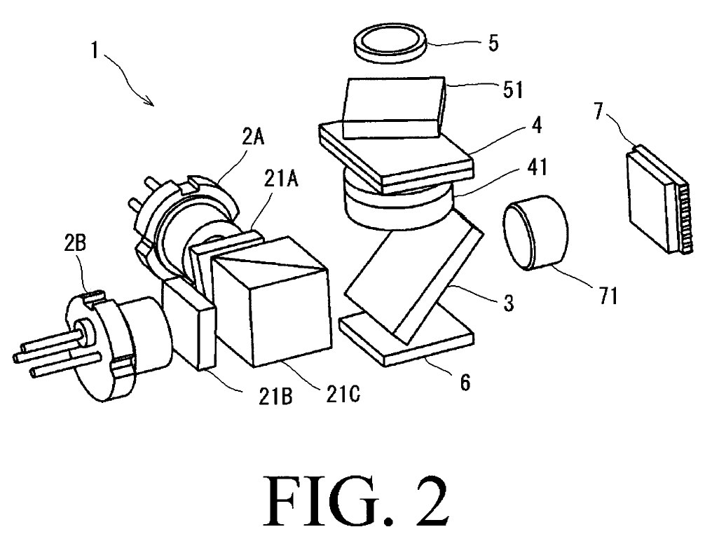

Hereinbelow, a description will be made with regard to the actual embodiment of the optical system of the optical pick-up device 1 of the first embodiment described above. FIG. 2 is a perspective view which shows the actual embodiment of the optical system of the optical pick-up device 1 shown in FIG. 1. The optical pick-up device 1 includes a laser diode 2A for CDs and a laser diode 2B for DVDs. Therefore, on the laser beam emitting sides of the laser diode 2A and the laser diode 2B, diffraction gratings 21A, 21B are provided, respectively. Further, there is provided a wavelength selectionable beam splitter 21C for introducing the laser beam emitted from each of the laser diodes 2A and 2B to the polarization mirror 3. In this regard, it is to be noted that the reference numeral 41 denotes a collimator lens, the reference numeral 51 denotes a light shading plate for cutting off ambient light of the laser beam for CDs, and the reference numeral 71 is a sensor lens.

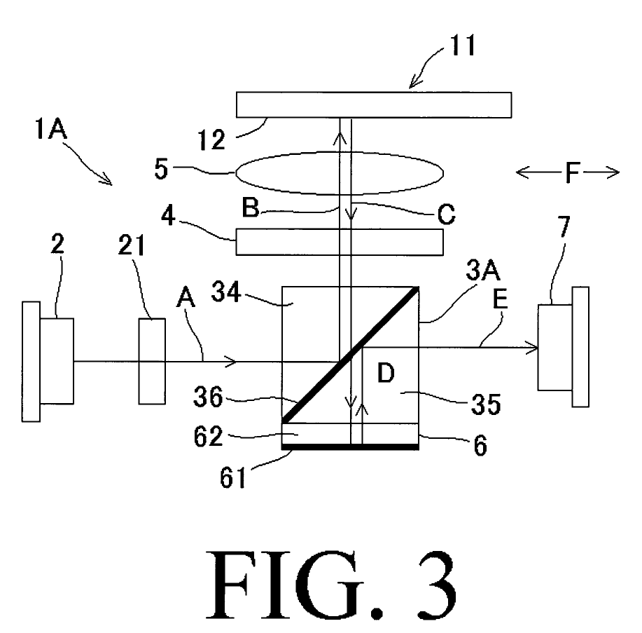

Next, with reference to FIG. 3, a description will be made with regard to an optical system of an optical pick-up device of a second embodiment according to the present invention. FIG. 3 is a schematic view which schematically shows a concept of the optical system of the second embodiment of the optical pick-up device 1A according to the present invention, in which the reference numerals same as those used in the first embodiment denote the same components.

In the optical pick-up device 1A, a polarization beam splitter 3A is used instead of the polarization mirror 3 used in the first embodiment. The polarization beam splitter 3A includes a first prism 34 which is arranged on the side that faces the laser diode 2, a second prism 35 which is arranged on the side that faces the photodiode 7, a semi-reflective film 36 provided between joint surfaces of the first and second prisms 34, 35. The semi-reflective film 36 is inclinedly provided at an angle of 45° with respect to the direction in parallel to the disc recording surface 12.

Further, the quarter wavelength plate 6 is directly attached to the bottom surface of the polarization beam splitter 3A. Therefore, it is possible to reduce a height of the optical pick-up device (a size in a vertical direction with respect to the disc recording surface). Further, it is not necessary to make adjustment of mounting angle of the quarter wavelength plate 6 or the like as an independent component.

The operation and effect of the second embodiment are substantially the same as those of the first embodiment. In this regard, it is to be noted that the polarization beam splitter 3A reflects the s-polarized laser beam in the outward path A, transmits the p-polarized laser beam in the returning path C, and reflects the s-polarized laser beam in the returning path C.

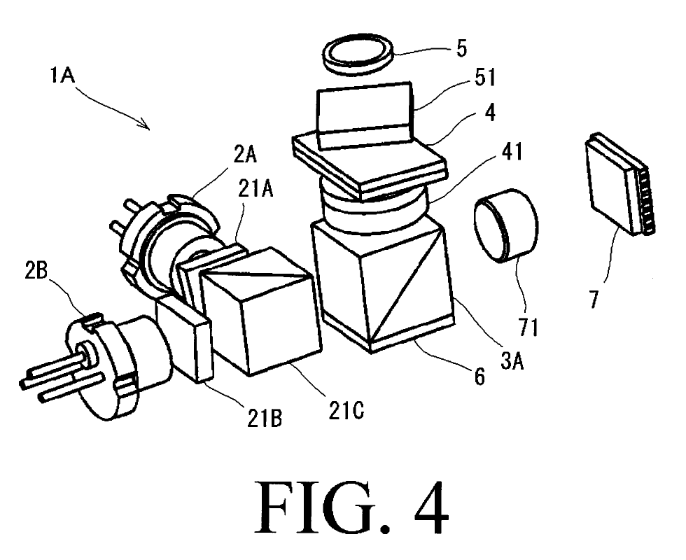

FIG. 4 shows an actual embodiment of the optical system of the optical pick-up device 1A of the second embodiment. The second embodiment is the same as the first embodiment except that the polarization beam splitter 3A is used instead of the polarization mirror 3 and the quarter wavelength plate 6 is directly attached to the polarization beam splitter 3A.

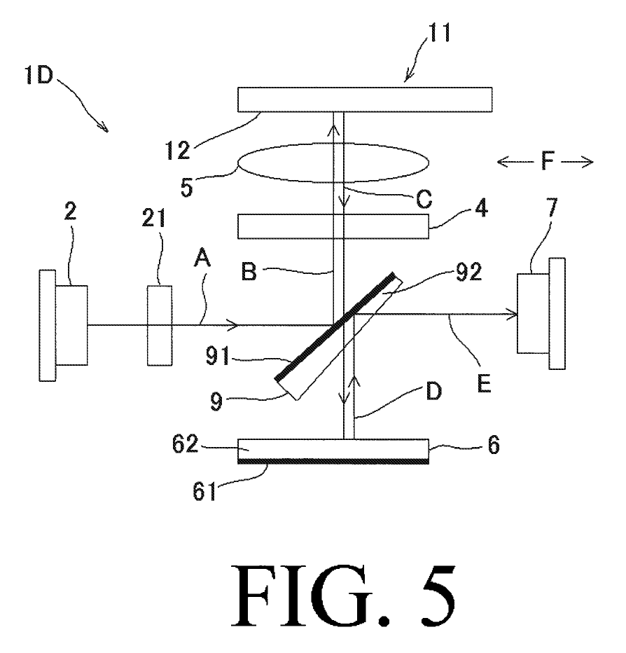

Next, with reference to FIG. 5, a description will be made with regard to an optical system of an optical pick-up device of a third embodiment according to the present invention. FIG. 5 is a schematic view which schematically shows a concept of the optical system of the third embodiment of the optical pick-up device 1D according to the present invention, in which the reference numerals same as those used in the first embodiment denote the same components.

In the optical pick-up device 1D of this third embodiment, a wedge-shaped polarization mirror 9 is used instead of the polarization mirror 3 of the first embodiment. According to the third embodiment, in the case where non-parallel beams are incident on the wedge-shaped polarization mirror 9 in the outward path A and the returning path D, it is possible to cancel the astigmatism produced by the non-parallel beams effectively. In this regard, it is to be noted that the reference numeral 91 denotes a polarization film and the reference numeral 92 denotes a wedge-shaped light transmission body.

### INDUSTRIAL UTILIZATION

According to the present invention, since the light emitting element and the light receiving element are arranged on the opposite sides of the polarization reflective member in a direction parallel to the recording surface of the optical disc, respectively, the components of the optical pick-up device can be arranged on different sides of the polarization reflective member effectively so that a dead space in the optical pick-up device can be reduced. Further, according to the present invention, in the outward path for projecting the laser beam onto the disc recording surface, the laser beam emitted from the light emitting element is reflected on the polarization semi-reflecting member, polarized by the quarter wavelength plate, and then passed through the objective lens so that the laser beam is focused on the recording surface of the optical disc. This means that necessary minimum number of optical components are disposed on the outward path of the laser beam, and this makes it possible to reduce aberrations of the laser beam on the recording surface of the optical disc. Further, since it is also possible to reduce astigmatism effectively, a manufacturing cost for eliminating such astigmatism becomes unnecessary.

Finally, it should be understood that the present disclosure relates to subject matter contained in Japanese Patent Application No. 2005-25284 (filed on Aug. 31, 2005) which is expressly incorporated herein by reference in its entirety.

What is claimed is:

1. An optical pick-up device, comprising:
a light emitting element which emits a laser beam;
a polarization semi-reflective member which reflects or transmits the laser beam;
a quarter wavelength plate with a reflective film which reflects and polarizes the laser beam;
an objective lens which projects the laser beam onto a recording surface of an optical disc; and
a light receiving element which receive the laser beam;
wherein the objective lens, the quarter wavelength plate, the polarization semi-reflective member, and the quarter wavelength plate with a reflective film are arranged in this order from the side of the recording surface of the optical disc in a vertical direction with respect to the recording surface of the optical disc; and the light emitting element and the light receiving element are respectively arranged on the opposite sides of the polarization semi-reflective member in a direction parallel to the recording surface of the optical disc; and
wherein in an outward path for projecting the laser beam onto the recording surface of the optical disc, the laser beam emitted from the light emitting element is reflected on the polarization semi-reflective member, polarized by the quarter wavelength plate, and then passed through the objective lens so that the laser beam is focused on the recording surface of the optical disc, and in a returning path for receiving the laser beam reflected on the recording surface of the optical disc, the laser beam reflected on the recording surface of the optical disc is polarized by the quarter wavelength plate, transmitted through the polarization semi-reflective member, reflected on the reflective film of the quarter wavelength plate with a reflective film, and then reflected on the polarization semi-reflective member so that the laser beam is received by the light receiving element.

2. The optical pick-up device as claimed in claim 1, wherein the polarization semi-reflective member includes a polarization mirror having a polarization film provided on the side of the light emitting element thereof and a light transmissive body provided on the side of the light receiving element thereof, wherein the polarization mirror is inclinedly arranged at an angle of 45° with respect to the recording surface of the optical disc so that in the outward path the laser beam emitted from the light emitting element is reflected on the polarization film of the polarization mirror at an angle of 90° toward the recording surface of the optical disc and in the returning path the laser beam reflected on the reflective film of the quarter wavelength plate with a reflective film is reflected on the polarization film at an angle of 90° toward the light receiving element.

3. The optical pick-up device as claimed in claim 1, wherein the polarization semi-reflective member includes a wedge-shaped polarization mirror having a polarization film provided on the side of the light emitting element thereof and a wedge-shaped light transmissive body provided on the side of the light receiving element thereof, wherein the wedge-shaped polarization mirror is inclinedly arranged at an angle of 45° with respect to the recording surface of the optical disc so that in the light emitting path the laser beam emitted from the light emitting element is reflected on the polarization film of the wedge-shaped polarization mirror at an angle of 90° toward the recording surface of the optical disc and in the returning path the laser beam reflected on the reflective film of the quarter wavelength plate with a reflective film is reflected on the polarization film at an angle of 90° toward the light receiving element.

4. The optical pick-up device as claimed in claim 1, wherein the polarization semi-reflective member includes a polarization beam splitter having a first prism provided on the side of the light emitting element thereof, a second prism provided on the side of the light receiving element thereof, and a semi-reflective film provided between joint surfaces of the first and second prisms, wherein the semi-reflective film of the polarization beam splitter is inclinedly arranged at an angle of 45° with respect to the recording surface of the optical disc so that in the outward path the laser beam emitted from the light emitting element is reflected on the semi-reflective film of the polarization beam splitter at an angle of 90° toward the recording surface of the optical disc and in the returning path the laser beam reflected on the reflective film of the quarter wavelength plate is reflected on the semi-reflective film of the polarization beam splitter at an angle of 90° toward the light receiving element.
